(19) United States
(12) Patent Application Publication
(10) Pub. No.: US 2007/0250518 A1
(43) Pub. Date: Oct. 25, 2007

(54) Method and system for correlating location information of a server

(76) Inventors: Simon C. Chu, Chapel Hill, NC (US); Richard A. Dayan, Wake Forest, NC (US); Eric R. Kern, Chapel Hill, NC (US); Phuong T. Nguyen, Cary, NC (US)

Correspondence Address: SAWYER LAW GROUP LLP, PO BOX 51418, PALO ALTO, CA, 94303, US

(21) Appl. No.: 11/407,566

(22) Filed: Apr. 19, 2006

(51) Int. Cl. G06F 7/00

(52) U.S. Cl. 707/100

(57) ABSTRACT

A method and system for correlating location information of a server. More particularly, embodiments of the present invention provide a method that includes causing a node to obtain correlation of a first address of at least one target server with a second address of the at least one target server based on the second address of the at least one target server and a plurality of addresses similar in type to the first address. The method further includes retrieving the correlation from the node. As a result, a client may access the correlated location information and communicate directly with the target server.

### FIELD OF THE INVENTION

The present invention relates to computer systems, and more particularly to a method and system for correlating location information of a server.

### BACKGROUND OF THE INVENTION

In server blade systems, the blade position or slot number in a BladeCenter chassis is typically known only to the management module of a given blade chassis. Slot numbers are used extensively by the management module for identifying particular server blades in order to perform management functions (e.g., upgrading software at a given server blade). A problem with conventional server blade systems is that remote clients accessing a server blade resident in a BladeCenter typically have only limited location information of the server blade. For example a remote client may have only the internet protocol (IP) address but may not know the blade position that the IP address represents. Unfortunately, the management module typically cannot provide the blade position for a given IP address, because the management module typically does not store the IP address. Furthermore, the management module typically does not communicate with the operating system (OS) running on the server blade and typically communicates only with the service processor of a given server blade. Still further, the OS is unaware of the management module. Consequently, a remote client cannot perform management functions on a given server blade, since the client does not have the IP address of the server blade.

Accordingly, what is needed is a method and system for correlating location information of a server. The present invention addresses such a need.

### SUMMARY OF THE INVENTION

A method and system for correlating location information of a server is disclosed. More particularly, embodiments of the present invention provide a method that includes causing a node to obtain correlation of a first address of at least one target server with a second address of the at least one target server based on the second address of the at least one target server and a plurality of addresses similar in type to the first address. The method further includes retrieving the correlation from the node. As a result, a client may access the correlated location information and communicate directly with the target server.

### BRIEF DESCRIPTION OF THE DRAWINGS

FIG. 1 is a block diagram of a BladeCenter system in accordance with the present invention.

FIG. 2 is a perspective view of the rear portion of the BladeCenter system of FIG. 1, in accordance with the present invention.

FIG. 3 is a schematic diagram of a management subsystem of a server blade system in accordance with the present invention.

FIG. 4 is a topographical illustration of management functions of a server blade system in accordance with the present invention.

FIG. 5 is a flow chart showing a method for correlating location information in accordance with the present invention.

FIG. 6 is a flow chart showing a method for obtaining location information in accordance with the present invention.

FIG. 7 is a flow chart showing a method for obtaining an Internet Protocol address in accordance with the present invention.

### DETAILED DESCRIPTION OF THE INVENTION

The present invention relates to computer systems, and more particularly to a method and system for correlating location information of a server. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiments shown, but is to be accorded the widest scope consistent with the principles and features described herein.

A method and system in accordance with the present invention for correlating location information of a server are disclosed. In accordance with the present invention, a management module transmits a command to a switch. The command causes the switch to issue an address resolution protocol (ARP) request to one or more blade servers. Each ARP request includes one IP address of the range of possible IP addresses such that the server that is associated with the one IP address transmits an ARP response to the switch. The ARP response includes the one IP address and the MAC address of the server, which may be stored in both the switch and management module for access by a remote client. As a result, the remote client may access the correlated location information and communicate directly with the server. To more particularly describe the features of the present invention, refer now to the following description in conjunction with the accompanying figures.

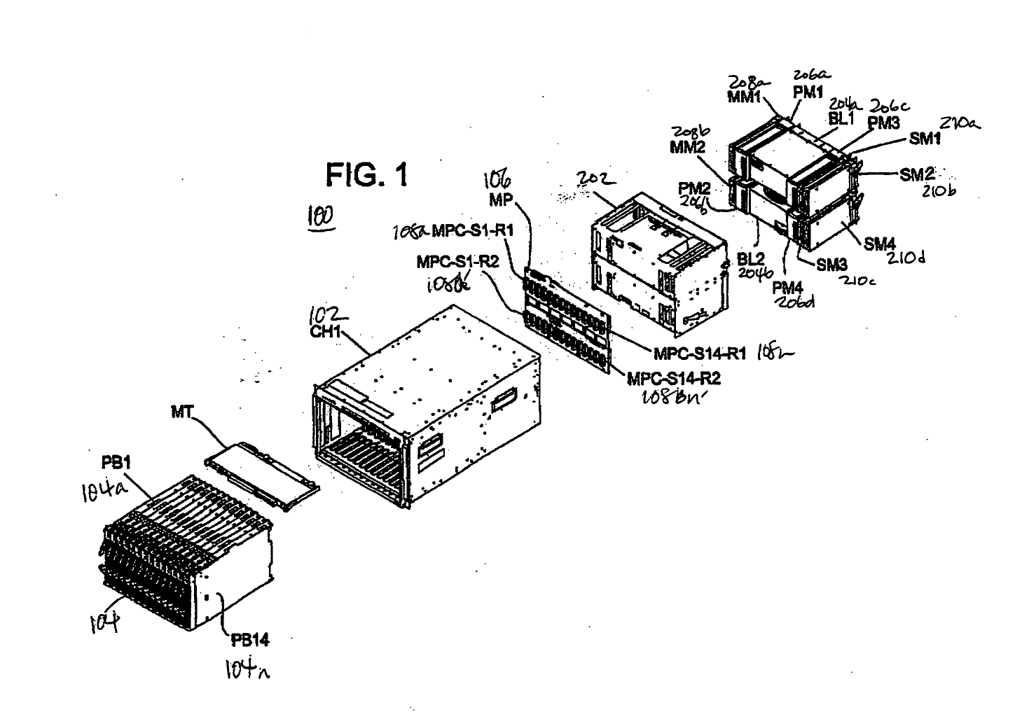

To describe further the features of the present invention, please refer to the following discussion and figures, which describe a computer system, such as the BladeCenter. FIG. 1 is an exploded perspective view of the BladeCenter system 100. Referring to this figure, a main chassis 102 houses all the components of the system. Up to 14 server blades 104 (or other blades, such as storage blades) are plugged into the 14 slots in the front of chassis 102. Some of the blades 104 may be “hot swapped” without affecting the operation of other blades 104 in the system 100. A server blade 104a can use any microprocessor technology so long as it is compliant with the mechanical and electrical interfaces, and the power and cooling requirements of the system 100.

A midplane circuit board 106 is positioned approximately in the middle of chassis 102 and includes two rows of connectors 108, 108′. Each one of the 14 slots includes one pair of midplane connectors, e.g., 108a, 108a′, located one above the other, and each pair of midplane connectors, e.g., 108a, 108a′ mates to a pair of connectors (not shown) at the rear edge of each server blade 104a.

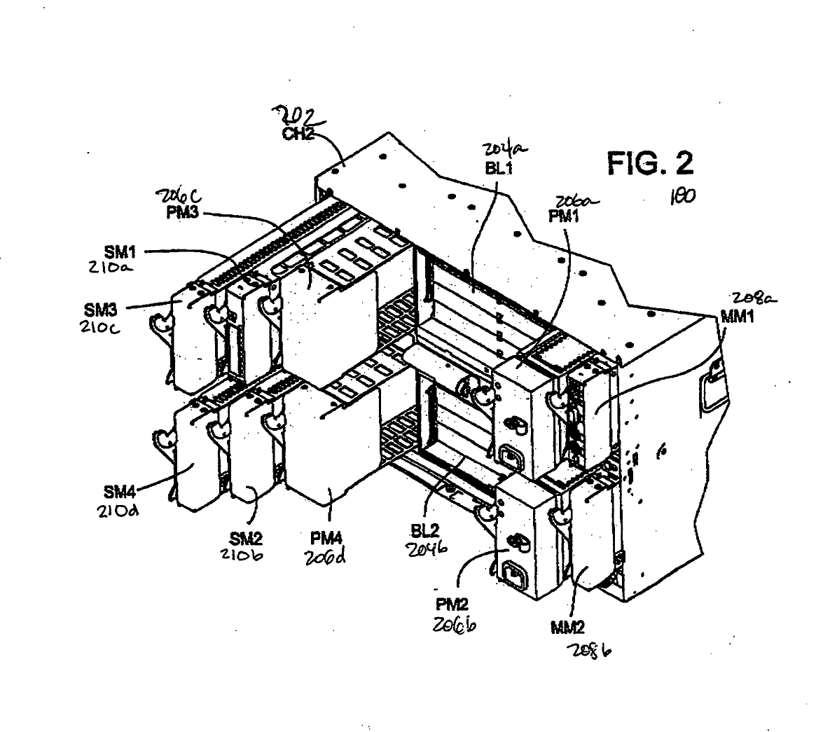

FIG. 2 is a perspective view of the rear portion of the BladeCenter system 100, whereby similar components are identified with similar reference numerals. Referring to FIGS. 1 and 2, a second chassis 202 also houses various components for cooling, power, management and switching. The second chassis 202 slides and latches into the rear of main chassis 102.

As is shown in FIGS. 1 and 2, two optionally hot-pluggable blowers 204a, 204b provide cooling to the blade system components. Four optionally hot-pluggable power modules 206 provide power for the server blades and other components. Management modules MM1 and MM2 (208a, 208b) can be hot-plugable components that provide basic management functions such as controlling, monitoring, alerting, restarting and diagnostics. Management modules 208 also provide other functions required to manage shared resources, such as multiplexing the keyboard/video/mouse (KVM) to provide a local console for the individual blade servers 104, configuring the system 100, and switching modules 210, each of which is also referred to as a switch 210.

The management modules 208 communicate with all of the key components of the system 100 including the switch 210, power 206, and blower 204 modules as well as the blade servers 104 themselves. The management modules 208 detect the presence, absence, and condition of each of these components. When two management modules are installed, a first module, e.g., MM1 (208a), will assume the active management role, while the second module MM2 (208b) will serve as a standby module.

The second chassis 202 also houses up to four switching modules SM1 through SM4 (210a-210d). The primary purpose of the switch module is to provide interconnectivity between the server blades (104a-104n), management modules (208a, 208b) and the outside network infrastructure (not shown). Depending on the application, the external interfaces may be configured to meet a variety of requirements for bandwidth and function.

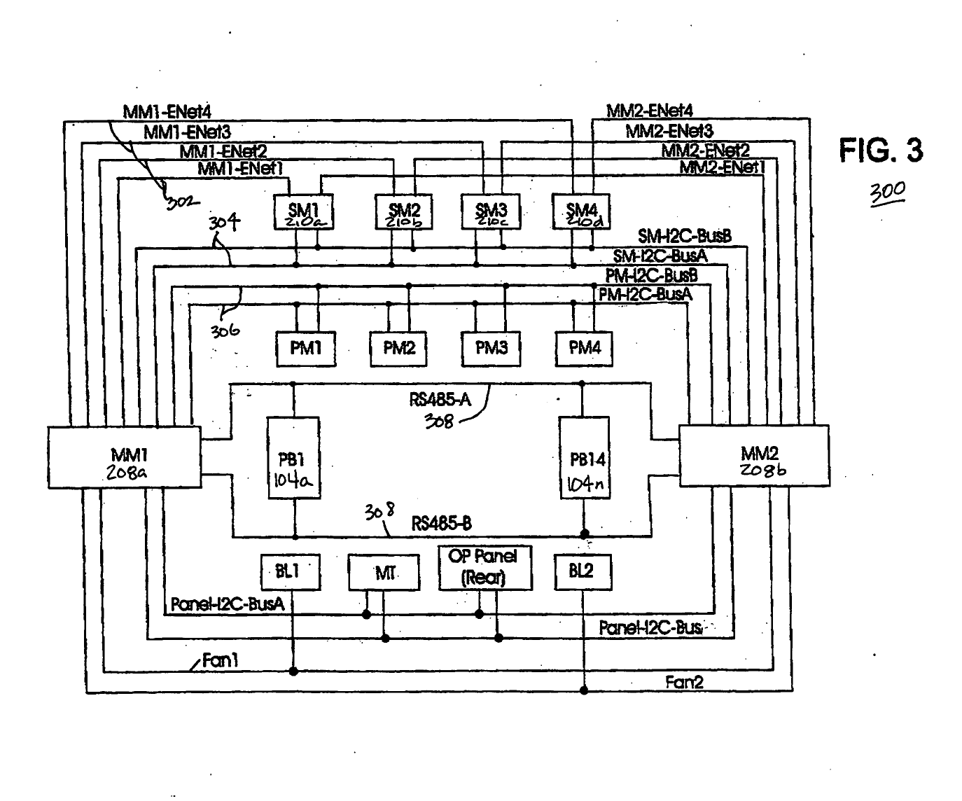

FIG. 3 is a schematic diagram depicting a management subsystem 300 of a server blade system, where like components share like identifying numerals. Referring to this figure, each management module (208a, 208b) has a separate Ethernet link (302), e.g., MM1-Enet1, to each one of the switch modules (210a-210d). In addition, the management modules (208a, 208b) are coupled to the switch modules (210a-210d) via two serial I2C buses (304), which provide for “out-of-band” communication between the management modules (208a, 208b) and the switch modules (210a-210d). Two serial buses (308) are coupled to server blades PB1 through PB14 (104a-104n) for “out-of-band” communication between the management modules (208a, 208b) and the server blades (104a-104n).

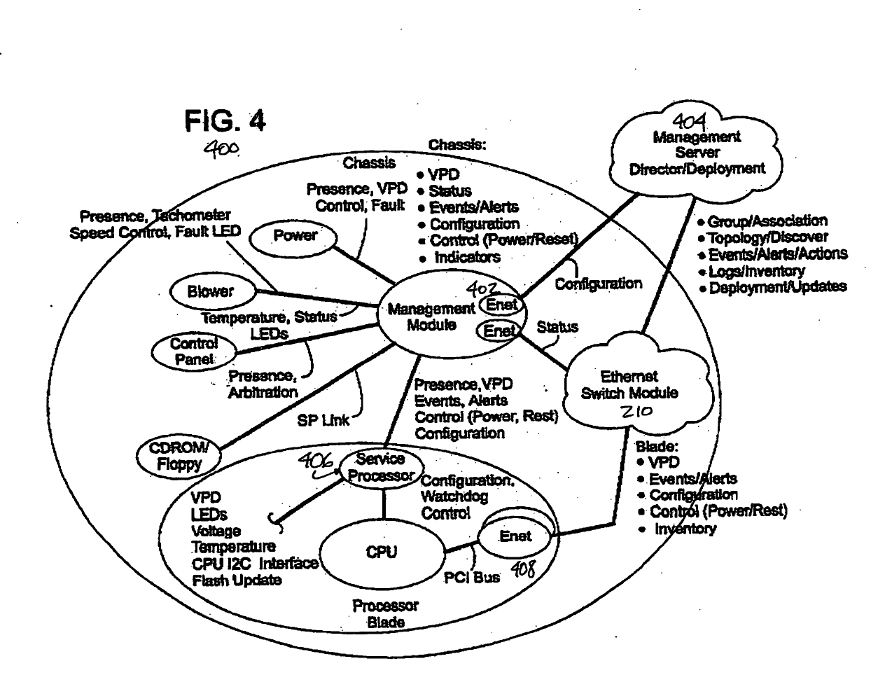

FIG. 4 is a topographical illustration of management functions of a server blade system in accordance with the present invention. Referring to FIGS. 3 and 4, each of the two management modules (208) has an Ethernet port 402 that is intended to be attached to a private, secure management server 404. The management module firmware supports a web browser interface for either direct or remote access. Each server blade 104 has a dedicated service processor 406 for sending and receiving commands to and from the management module 208. The data ports 408 that are associated with the switch modules 210 can be used to access the server blades 104 for image deployment and application management, but are not intended to provide chassis management services. The management module 208 can send alerts to a remote console, e.g., 404, to indicate changes in status, such as removal or insertion of a blade 104 or module. The management module 208 also provides access to the internal management ports of the switch modules 210 and to other major chassis subsystems (power, cooling, control panel, and media drives).

Referring again to FIGS. 3 and 4, the management module 208 communicates with each server blade service processor 406 via the out-of-band serial bus 308, with one management module 208 acting as the master and the server blade's service processor 406 acting as a slave. For redundancy, there are two serial busses 308 (one bus per midplane connector) to communicate with each server blade's service processor 406.

In general, the management module (208) can detect the presence, quantity, type, and revision level of each blade 104, power module 206, blower 204, and midplane 106 in the system, and can detect invalid or unsupported configurations. The management module (208) will retrieve and monitor critical information about the chassis 102 and blade servers (104a-104n), such as temperature, voltages, power supply, memory, fan and HDD status. If a problem is detected, the management module 208 can transmit a warning to a system administrator via the port 402 coupled to the management server 404. If the warning is related to a failing blade, e.g., 104a, the system administrator must replace the failed blade 104a. In order to preserve the information on the failed blade's 104a hard drive, the administrator must manually remove the hard drive and remount it into a replacement blade. This process is labor intensive and economically costly. The present invention resolves this problem.

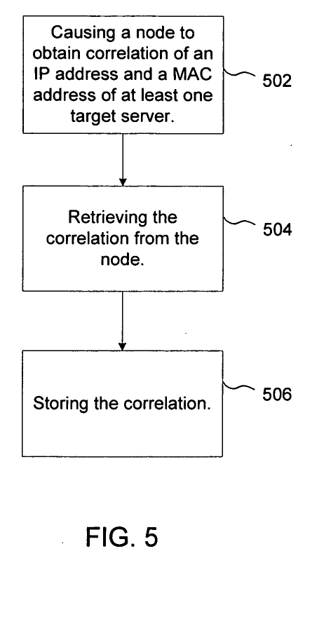

FIG. 5 is a flow chart showing a method for correlating location information in accordance with the present invention. Referring to both FIGS. 1 and 5 together, the process begins in step 502 where a management module 208 causes a node (e.g., the switch 210) to obtain correlation of an IP address of at least one target server (e.g., the server blade 104a) and a MAC address of the at least one target server based on the MAC address and multiple IP addresses. In one embodiment, the node obtains the correlation by issuing an address request (e.g., an ARP request) to multiple servers, where the address request includes the IP address of the least one target server. Among the multiple servers, the server (i.e., the target server) that has the IP address will respond with an address response (e.g., an ARP response) to the node, where the address response includes the IP address and the MAC address of the target server. The term “address resolution” refers to the process of finding an IP address of a computer or server in a network. The address is “resolved” using a protocol in which a server receives a piece of information, such as an IP address, and then responds to the sender of the piece of information. This allows the sender to uniquely identify the owner of the piece of information.

After obtaining the correlation, the node may then store the correlation in a memory location (e.g., in a cache table). The memory location contains entries of the IP address and associated MAC address of each server. Next, in a step 504, the management module 210 retrieves the correlation from the node (e.g., from the cache table of the node). Next, in a step 506, the management module 208 stores the correlation. In one embodiment, the management module 208 then correlates the IP address and MAC address of the target server with a server position (also referred to as a blade position or slot number) of the target server. The management module 208 then stores the location information (i.e., the IP address, MAC address, and server position) in a memory location (e.g., a table cache). As described in more detail below, a remote client may access the location information to enable the remote client to communicate directly with the node.

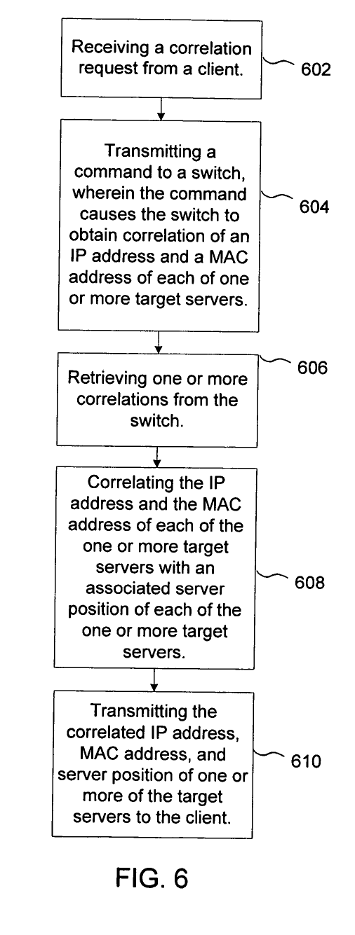

FIG. 6 is a flow chart showing a method for obtaining location information, implemented at a management module 208, in accordance with the present invention. Referring to both FIGS. 1 and 6 together, the process begins in step 602 where the management module 208 receives a correlation request from a client (e.g., a remote client). In one embodiment, the correlation request is a request to correlate an IP address with a server position (i.e., blade position/slot number) and/or a MAC address. Next, in a step 604, the management module 208 transmits a command to a switch 210, where the command causes the switch 210 to obtain a correlation of an IP address of each of one or more target servers (e.g., the blade servers 104) and an associated MAC address of each of the one or more target servers. In one embodiment, the correlation of a given target server may be based on the MAC address of the target server and a set of IP addresses, where each of the IP addresses is a possible IP address of the target server. Next in a step 606, the management module 208 retrieves one or more correlations from the switch 210. In one embodiment, the management module 208 already stores the assigned server positions for each server in the blade chassis and stores the MAC addresses associated with each server. The management module 208 also stores the set of IP addresses. Next, in a step 608, the management module 208 correlates the IP address and the MAC address of each of the one or more target servers (received from the switch 210) with a server position (i.e., blade position/slot number) of each of the one or more target servers. The management module 208 then stores the correlated IP address, MAC address, and server position (e.g., in a table cache or other suitable memory location) of each target server. Next, in a step 610, the management module 208 transmits the IP address, MAC address, and server position of one or more target servers to the client. The client can then filter out the IP address of each server and map the IP address to the associated server position(s).

In one embodiment, the management module 208 may perform the above-described process for one target server and then may repeat the process to obtain correlated location information (i.e., respective IP address, MAC address, and server position) for all of the servers. At the end of this process, a client would have a complete table uniquely mapping the IP address to a server position for each server. In another embodiment, the management module 208 may transmit a command to the switch 210 that may cause the switch 210 to transmit multiple ARP requests, where each ARP request contains a different IP address from a set of possible IP addresses in order to eventually obtain ARP responses from all of the servers. Accordingly, the switch 210 obtains correlated location information (i.e., IP address and MAC address) for each of the servers. As such, the management module 208 may retrieve all of the correlations from the switch 210 and then correlate the IP addresses and MAC addresses from those correlations with respective server positions (i.e., blade position/slot numbers). In one embodiment, the management module 208 stores the correlated location information in any suitable memory location such as a cache table. In one embodiment, the management module 208 may generate an internal table by reading vital product data (VPD) from the servers through an RS486 network.

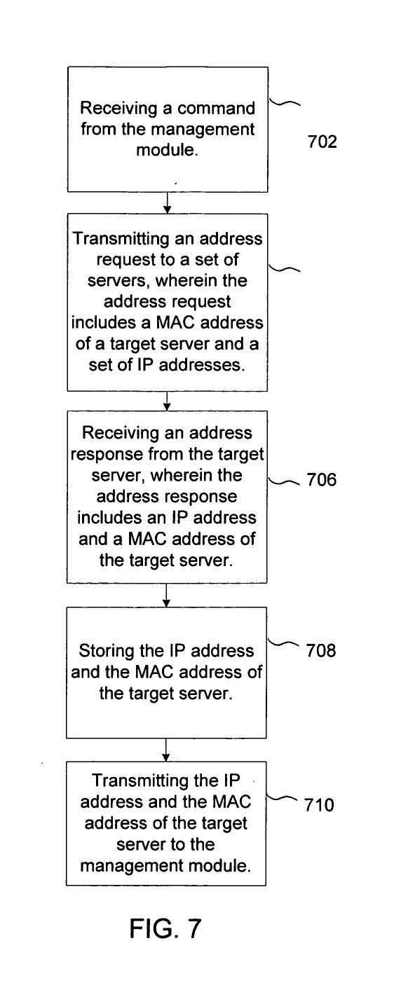

FIG. 7 is a flow chart showing a method for obtaining an Internet Protocol address, implemented at a switch 210, in accordance with the present invention. Referring to both FIGS. 1 and 7 together, the process begins in step 702 where the switch 210 receives a command from the management module 208. Next, in a step 704, the switch 210 transmits one or more requests (e.g., an ARP request) to multiple servers using the internal ports of the switch (i.e., the ports connected to the servers), where each of the address requests includes a MAC address of a target server and a set of IP addresses. Each IP address is a possible IP address of a given target server. Next, in a step 706, the switch 210 receives an address response from the target server, where the address response includes an IP address and the MAC address of the target server. Next, in a step 708, the switch 210 stores the IP address and the MAC address of the target server. In one embodiment, the switch 210 stores the correlated location information (i.e., the IP address and MAC address) in a memory such as in a cache table or ARP table. Finally, in a step 710, the switch transmits the IP address of the target server to the management module.

According to the system and method disclosed herein, the present invention provides numerous benefits. For example, embodiments of the present invention enable a client to access the correlated location information and communicate directly with the target server. Embodiments of the present invention also provide a remote client with a consistent and reliable means to access the IP address and/or blade number/position of a given blade in a chassis.

A method and system for correlating location information of a server has been disclosed. In accordance with the present invention, a management module transmits a command to a switch. The command causes the switch to issue an address resolution protocol (ARP) request to one or more blade servers. Each ARP request includes one IP address of the range of possible IP addresses such that the server that is associated with the one IP address transmits an ARP response to the switch. The ARP response includes the one IP address and the MAC address of the server, which may be stored in both the switch and management module for access by a remote client. As a result, the remote client may access the correlated location information and communicate directly with the server.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD-ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A method for correlating location information of a server, the method comprising:
causing a node to obtain correlation of a first address of at least one target server with a second address of the at least one target server based on the second address of the at least one target server and a plurality of addresses similar in type to the first address; and
retrieving the correlation from the node.

2. The method of claim 1 further comprising correlating the first address and the second address of the at least one target server with a server position of the at least one target server.

3. The method of claim 2 wherein the server position is a slot number.

4. The method of claim 1 further comprising:
receiving a correlation request from a client; and
transmitting the first address, the second address, and the server position to the client in response to the correlation request.

5. The method of claim 1 wherein the first address is an Internet Protocol (IP) address.

6. The method of claim 1 wherein the second address is a media access control (MAC) address.

7. The method of claim 1 wherein the node is a switch.

8. A computer-readable medium containing program instructions for correlating location information of a server, the program instructions which when executed by a computer system cause the computer system to execute a method comprising:
causing a node to obtain correlation of a first address of at least one target server with a second address of the at least one target server based on the second address of the at least one target server and a plurality of addresses similar in type to the first address; and
retrieving the correlation from the node.

9. The computer-readable medium of claim 8 further comprising program instructions for correlating the first address and the second address of the at least one target server with a server position of the at least one target server.

10. The computer-readable medium of claim 9 wherein the server position is a slot number.

11. The computer-readable medium of claim 8 further comprising program instructions for:
receiving a correlation request from a client; and
transmitting the first address, the second address, and the server position to the client in response to the correlation request.

12. The computer-readable medium of claim 8 wherein the first address is an Internet Protocol (IP) address.

13. The computer-readable medium of claim 8 wherein the second address is a media access control (MAC) address.

14. The computer-readable medium of claim 8 wherein the node is a switch.

15. A server system comprising:
at least one management module;
a node coupled to the management module, wherein the management module causes the node to obtain correlation of a first address of at least one target server with a second address of the at least one target server based on the first address of the at least one target server and a plurality of addresses similar in type to the first address; and
at least one server coupled to the node.

16. The system of claim 15 wherein the management module correlates the first address and the second address of the at least one target server with a server position of the at least one target server.

17. The system of claim 16 wherein the server position is a slot number.

18. The system of claim 15 wherein the management module receives a correlation request from a client and transmits the first address, the second address, and the server position to the client in response to the correlation request.

19. The system of claim 15 wherein the first address is an Internet Protocol (IP) address.

20. The system of claim 15 wherein the second address is a media access control (MAC) address.

21. The system of claim 15 wherein the node is a switch.

22. A method for correlating location information of a server, the method comprising:
receiving a command from a management module;
transmitting an address request to a plurality of servers, wherein the address request includes a first address of a target server and a set of addresses similar in type to a second address of the target server;
receiving an address response from the target server, where the address response includes the first address and the second address of the target server;
storing the first address and the second address in a memory location; and
transmitting the first address and the second address of the target server to the management module.

23. The method of claim 22 wherein the address request is an address resolution protocol request.

24. The method of claim 23 wherein the set of addresses similar in type to the second address comprises the second address of the target server.

25. The method of claim 24 further comprising storing the correlated location information in a memory.

26. The method of claim 22 wherein the first address is a media access control (MAC) address.

27. The method of claim 22 wherein the second address is an Internet Protocol (IP) address.

28. The method of claim 22 wherein the memory location is a table.
